(19) United States
(12) Patent Application Publication
(10) Pub. No.: US 2003/0021052 A1
(43) Pub. Date: Jan. 30, 2003

(54) Erasing apparatus for magnetic recording medium

(76) Inventor: Toshiharu Yoshikawa, Osaka (JP)

Correspondence Address: Mr. Charles, W. Fallow, SHOEMAKER AND MAITARE, LTD., Crystal Plaza Bldg. I, Suite 1203, 2001 Jefferson Davis Highway, Arlington, VA, 22202-0286, US

(21) Appl. No.: 10/108,516

(22) Filed: Apr. 29, 2002

(30) Foreign Application Priority Data
Jul. 27, 2001 (JP) 2001-004923

(51) Int. Cl. G11B 5/03

(52) U.S. Cl. 360/66

(57) ABSTRACT

An erasing apparatus for a magnetic recording medium is provided to instantaneously remove data recorded on the recording medium, so that the erased data is no longer readable. The erasing apparatus includes a transporter for carrying the recording medium to magnetic field, a positioner for setting the recording medium in position, an electromagnet for generating magnetic field, and a power source for the electromagnet.

### FIELD OF THE INVENTION

The present invention relates to erasing apparatuses for magnetic recording data, and more particularly, to an apparatus for erasing data recorded on a medium such as a hard disk through the use of an external magnetic field.

### BACKGROUND OF THE INVENTION

Information, such as images or pictures, sounds, computer programs and various data, recorded on a magnetic medium can be removed by erasure operation of a recording device in connection with the recording medium.

As shown in FIG. 2, information recorded on a recording medium is eliminated by programs attached to a recording device. However, it is time-inefficient to erase data completely, from a hard disk with large storage capacity.

For a marketed recording device, in order to shorten data-elimination time, alternatively as shown in FIG. 2, for example, data recorded at a magnetic sector on the inner circumference of a magnetic medium is erased, which prevents one from accessing the part where required information is recorded in the recording device.

However, when one discards a recording medium or a recording device containing the recording medium that is performed with data elimination by the above-described method, information stored in the discarded recording medium is still easily readable by a third person, thereby making information security hardly achieved.

### SUMMARY OF THE INVENTION

A primary objective of the present invention is to provide an erasing apparatus for a magnetic recording medium, allowing one to instantaneously and completely remove data recorded on a single recording medium, or a recording medium built into a recording device or a computer.

In accordance with the above and other objectives, the present invention proposes an erasing apparatus for a magnetic recording medium, comprising: a magnet for generating a magnetic field; a power source for controlling magnitude of the magnetic field; a transporter for automatically or manually carrying the magnetic recording medium to the magnetic field; and a positioner for setting the magnetic recording medium in position.

The recording medium is placed in the magnetic field generated by the magnet in a manner that, the magnetic field evenly irradiates the recording medium for completely erasing data stored in the recording medium, so that the erased data is not further readable or retrievable by any method. The magnetic field must be larger in magnitude than maintenance strength of the recording medium, and irradiation time of the magnetic field is good at an instant.

Therefore, the instant data erasure achieved in this invention is greatly more time-efficient and beneficial than the prior art, in which one needs to take a couple of hours to perform a complete elimination way of data erasure, or a few minutes to carry out simple elimination way for erasing data.

In a preferred embodiment of the invention, the erasing apparatus comprises: an electromagnet, a power source for supplying power to the electromagnet, a transporter for placing a magnetic recording medium in a magnetic field generated by the electromagnet, and an adjusting device for adjusting magnitude of the magnetic field; whereby data recorded on the magnetic recording medium can be erased through the use of the erasing apparatus.

As the magnetic field is generated by the electromagnetic quickly, accordingly little heat is produced by coils of the electromagnet, and it is therefore not necessary to perform compulsive air or water cooling, allowing the erasing apparatus to be miniaturized in profile.

The power source is adapted to supply constant electric currents. More preferably, a battery device is used to accumulate electric charges and instantly supply power to the electromagnet, by which the erasing apparatus can be profile-miniaturized and made more power-effective to operate, thereby reducing manufacturing costs significantly.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing an embodiment of an erasing apparatus of the invention; and

FIG. 2 (PRIOR ART) is a flowchart showing a conventional process of data elimination.

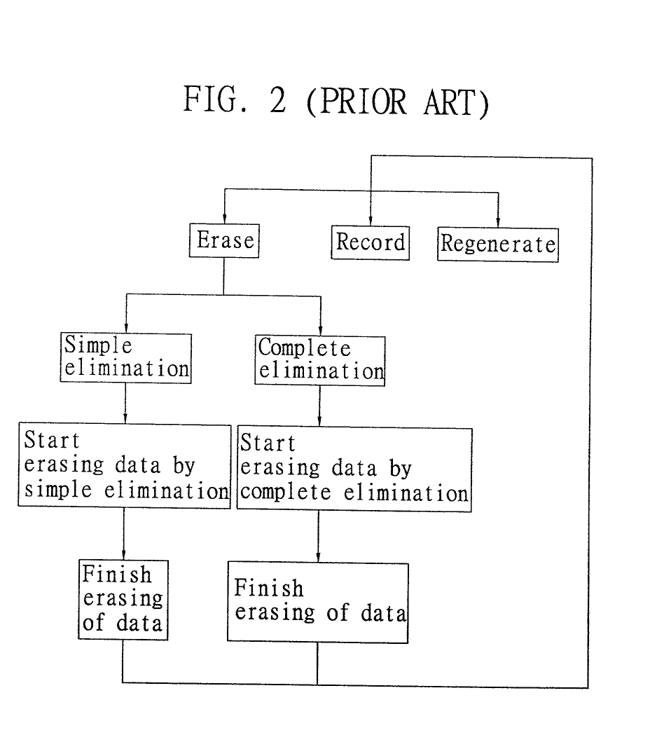

### DETAILED DESCRIPTION OF THE PREFERRED EMBODIMENTS

Recording media includes the ROM (read-on memory) type that are not recordable, and the RAM (random access memory) type that are repeatedly recordable. Images, sounds, computer programs and various data can be stored in either type of recording media.

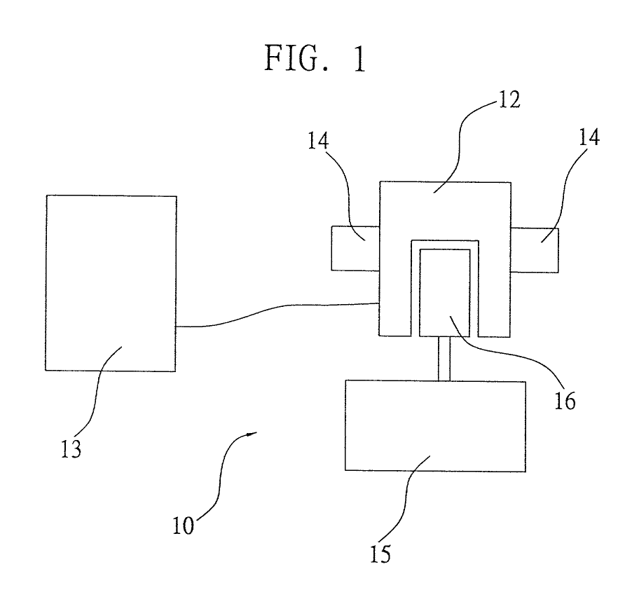

The following description is made with reference to FIG. 1, which depicts an erasing apparatus embodying this invention for removing data recorded on a magnetic recording medium through the use of an external magnetic field. It should be noted that the following preferred embodiment does not set any restriction to the scope of this invention.

As shown in FIG. 1, the erasing apparatus 10 of the invention comprises: an electromagnet 12 for generating a magnetic field; a power source 13 for supplying electricity to the electromagnet 12; an adjusting device 14 for adjusting interval distance between magnetic poles; a transporter 15 for moving a subject from which data is to be erased; and a positioner 16 for positioning the subject.

In operation, first, a magnetic recording medium or a device 17 containing the same is directly placed in the magnetic field generated by the electromagnet 12, or alternatively transported to the magnetic field by the transporter 15 and the positioner 16. Next, the power source 13 supplies electric currents to the electromagnet 12 in a manner as to cause the magnetic field to become larger than maintenance strength of the recording medium, whereby a magnetic body in the recording medium would be magnetized toward a direction of magnetic lines of force generated by the electromagnet 12, and data recorded in the recording medium can be completely erased.

Therefore, the above-erased data from the magnetic recording medium are not further readable or retrievable by any methods, and thus data security is desirably assured.

In the above-described embodiment of the invention, an electromagnet is utilized to generate a magnetic field; instead, a permanent magnet is also be suitably applied. Moreover, the erasing apparatus of the invention is exemplified as a fixed type of equipment, but the erasing apparatus can be made portable by using a small electromagnet, and flexibly operated with a recording medium for data erasure.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An erasing apparatus for a magnetic recording medium, comprising:
a magnetic means for generating a magnetic field;
a power source for supplying power to the magnetic means; and
a transporting means for placing the magnetic recording medium in the magnetic field.

2. The erasing apparatus of claim 1, wherein the magnetic means is an electromagnet that is capable of adjusting magnitude of the magnetic field.

3. The erasing apparatus of claim 2, wherein the magnetic field is adjusted in magnitude corresponding to scale of the magnetic recording medium.

4. The erasing apparatus of claim 1, wherein the power source is provided with a battery device having a large capacity, the battery device being capable of controlling power output and instantly supplying a large amount of power.

5. The erasing apparatus of claim 1, wherein the erasing apparatus further comprises a manually-operable means for manually transporting the magnetic recording medium to the magnetic field.

6. The erasing apparatus of claim 1, wherein the erasing apparatus further comprises a positioning means for allowing the magnetic recording medium to be evenly applied with the magnetic field.

7. The erasing apparatus of claim 1, wherein the magnetic recording medium is singly built.

8. The erasing apparatus of claim 1, wherein the magnetic recording medium is built in a recording device.

9. The erasing apparatus of claim 1, wherein the magnetic recording medium is built in a computer device.
